(19) United States
(12) Patent Application Publication
(10) Pub. No.: US 2012/0122569 A1
(43) Pub. Date: May 17, 2012

(54) RECONFIGURABLE GAME MACHINE

(75) Inventors: Robert G. Kowolik, Henderson, NV (US); James W. Stockdale, Clio, CA (US); Alexander Popovich, Henderson, NV (US); Aaron Hightower, Las Vegas, NV (US); William McMaster, Las Vegas, NV (US)

(73) Assignee: IGT, Reno, NV (US)

(21) Appl. No.: 12/946,784

(22) Filed: Nov. 15, 2010

(51) Int. Cl. A63F 13/00

(52) U.S. Cl. 463/30

(57) ABSTRACT

A reconfigurable game machine consists of an electronic game machine supported by an adjustable frame. A control system is configured to automatically adjust the elevation of a main display of the electronic game machine from a first elevation associated with a first angle associated with a first game to a second elevation associated with a second angle associated with a second game. The control system may automatically adjust a respective position of the user interface panel. The electronic game machine may be configured to offer a game selected from any of a plurality of games, and the control system is configured to automatically position the adjustable frame so as to support the main display at an angle and an elevation appropriate to the selected game.

### FIELD OF THE INVENTION

This invention relates generally to an electronic game machine, and in particular, to techniques for providing a reconfigurable game machine having a controller that automatically adjusts an elevation and angle of the game machine main display and user interface panel.

### BACKGROUND OF THE INVENTION

The assignee of the present invention develops and manufactures casino and arcade game machines. Customers for such game machines, typically casino and/or arcade operators, desire game machines that cost-effectively attract and retain the patronage of players. These objectives are met, in part, by electronic game machines that may permit a user to select, from a given machine, any of a variety of games. Some of these games may simulate the look and feel of a traditional and popular mechanical game such as a slot machine, pachinko or roulette game, wheel of fortune, or pinball machine. Game machine customers and players desire improved verisimilitude and increased game play options from such machines.

### SUMMARY

The present inventors have recognized that the flexibility and verisimilitude of an electronic game machine, having a main display and a user interface panel, may be enhanced by providing for the automatic mechanical adjustment of a respective angle and elevation of the main display and of the user interface panel. The adjustment may take into account aesthetic and traditional game play aspects of a simulated mechanical game as well as player ergonomics. For example, a simulated pinball game may be advantageously presented with a game machine main display at an angle to horizontal of 45-60 degrees; whereas a simulated table game is preferably presented with the game machine main display in a horizontal position, and a simulated slots or pachinko game may be preferably displayed with the game machine main display in a vertical position. Selection of a game type from a plurality of options, advantageously, may cause the automatic mechanical adjustment of a viewing angle of the main display as appropriate for the selected game, while simultaneously adjusting an elevation of the main display and an angle and elevation of the user interface panel to accommodate ergonomic factors. In an embodiment, a player is afforded the capability of further adjusting an elevation of the main display and an angle and elevation of the user interface panel for the player's comfort.

In an embodiment a reconfigurable game machine may consist of an electronic game machine, an adjustable frame and a control system. The electronic game machine may have a main display, a user interface panel, and a processor communicatively coupled to the main display, the user interface panel and the control system. The adjustable frame may be configured to support the main display at an angle and an elevation, the angle being adjustable by the control system between a first angle associated with a first game and a second angle associated with a second game. The control system may be configured to (i) automatically adjust the elevation of the main display from a first elevation associated with the first angle to a second elevation associated with the second angle; and (ii) automatically adjust a respective position of the user interface panel.

In a further embodiment, the electronic game machine may be configured to offer a game selected from any of a plurality of games, and the control system may be configured to automatically position the adjustable frame so as to support the main display at an angle and an elevation appropriate to the selected game. The first angle may be substantially horizontal and the second angle may be substantially vertical. The adjustable frame may be configured to automatically adjust a respective angle and elevation of the user interface panel, to maintain an ergonomically appropriate position with respect to a player. The adjustable frame may be configured to automatically adjust a respective angle and elevation of an ancillary display, to maintain an ergonomically appropriate position of the ancillary display with respect to the player. The adjustable frame may be configured to adjust a respective angle and elevation of an ancillary display, in response to an input from the player independent of the selected game.

In a further embodiment, the electronic game machine is a video game machine configured to simulate a game selectable from among a at least two of: roulette, craps, a slots game, a pachinko game, a pinball game, skeeball, foosball, and air hockey. The adjustable frame may be configured to support the main display at a selectable inclined angle associated with a simulated game; and one or more play parameters of the simulated game may be affected by a value of a selected inclined angle. At least one play parameter of the simulated game may be affected by a value of a selected inclined angle. The simulated game may be pinball and the at least one play parameter may be an apparent acceleration of a ball under the simulated effect of gravity.

In a yet further embodiment, a selection of a game may be received, at a processor, by way of a user interface panel of an electronic game machine, the electronic game machine consisting of a main display, the user interface panel and the processor, and being configured to be supported by an adjustable frame. The adjustable frame may be configured to support the main display at an angle and an elevation, said angle being adjustable by the control system between a first angle associated with a first game and a second angle associated with a second game. The control system may automatically adjust (i) the elevation of the main display from a first elevation associated with the first angle to a second elevation associated with the second angle; and (ii) a respective position of the user interface panel.

### BRIEF DESCRIPTION OF THE DRAWINGS

Features of the invention are more fully disclosed in the following detailed description of the preferred embodiments, reference being had to the accompanying drawings, in which:

FIG. 1 illustrates a block diagram of an embodiment.

FIGS. 2A and 2B illustrates a reconfigurable game machine according to an embodiment

FIGS. 3A, 3B, and 3C illustrate a mechanism suitable for accomplishing reconfiguration of an adjustable frame according to an embodiment.

FIG. 4 illustrates a flow chart of a method embodiment.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

Certain features that are described in this specification in the context of separate embodiments also can be implemented in combination in a single embodiment. Conversely, various features that are described in the context of a single embodiment also can be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described and/or depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single product or packaged into multiple products. Additionally, other embodiments are within the scope of the following claims. In some cases, the actions recited in the claims can be performed in a different order and still achieve desirable results. Thus, the present invention may be embodied in many different forms, and should not be construed as limited to the embodiments set forth herein. Rather, these embodiments are provided so that this disclosure will be thorough and complete, and will fully convey the scope of the invention to those skilled in the art.

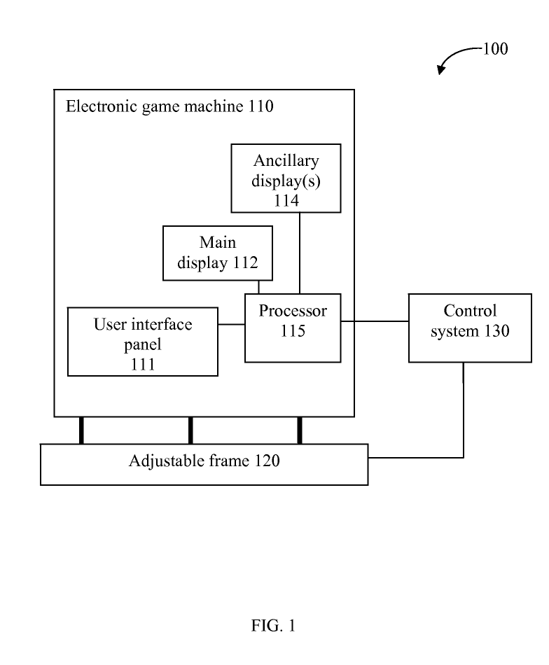

According to an embodiment of the presently disclosed techniques, referring to FIG. 1, a reconfigurable game machine 100 may consist of an electronic game machine 110, an adjustable frame 120, and a control system 130. Electronic game machine 110 may have one or more components normally associated with presenting a game, including a processor 115, as well as a cabinet, a master gaming controller, and apparatus for receiving and dispensing indicia of credit, etc. (not illustrated). In particular, electronic game machine 110, may consist of player input/output interfaces, including, for example, one or more displays and a user interface panel 111. In an embodiment, a main display 112 may be provided upon which game action may be presented. Advantageously, one or more ancillary displays 114 may be provided whereon, for example, game scores and/or payouts, bonus games, and promotional offers may be presented. User interface panel 111 may include any number of game controls, which may be normally hand-operated, such as buttons, levers, joy sticks, touch pads, etc. User interface panel 111 may also include devices for receiving and dispensing indicia of credit, for making a wager and for selecting a type of game, game variations, and game options.

In an embodiment, electronic game machine 110, or components thereof, are mounted to adjustable frame 120. Advantageously, main display 112 and user interface panel 111 may be mounted to adjustable frame 120 in a manner such that, as described hereinbelow, the main display 112 is supported at an angle and an elevation that may be adjusted by control system 130 between a first angle associated with a first game and a second angle associated with a second game.

Control system 130 may further be configured to control adjustable frame 120 so as to (i) automatically adjust the elevation of the main display from a first elevation associated with the first angle to a second elevation associated with the second angle; and (ii) automatically adjust a respective position of the user interface panel. Control system 130 may consist of hardware components such as mechanical linkages, motor drives and lead screws (not illustrated) and a software component that may control the foregoing hardware components while interfacing with processor 115 of electronic game machine 110. Although illustrated, for purposes of clarity, as a separate block in FIG. 1, it will be understood that control system 130 may be configured such that various components are distributed between electronic game machine 110, processor 115, and/or adjustable frame 120. For example, hardware components such as mechanical linkages, motor drives and lead screws various mechanical linkages may be incorporated into adjustable frame 120, whereas, certain control software may be incorporated into processor 115.

In an embodiment, selection of a change in game type may be made by way of user interface panel 111 and received by processor 115. In an embodiment, the selection may be made by a player. Alternatively, or in addition, processor 115 may be configured to act on a selection of a change in game type only after an enabling act (for example, insertion of a key or entry of a password) performed by an authorized person, for example, a game machine operator.

Upon recognizing entry of a valid selection of a change in game type, processor 115 may then command control system 130 to reconfigure adjustable frame 120. Where, for example, the change in game type is from a slot machine game type to a pinball game type, control system 130 may reconfigure adjustable frame 120 so as to provide that main display 112 is rotated from a near vertical orientation to a tilt angle inclined from horizontal by an amount associated with the pinball game type.

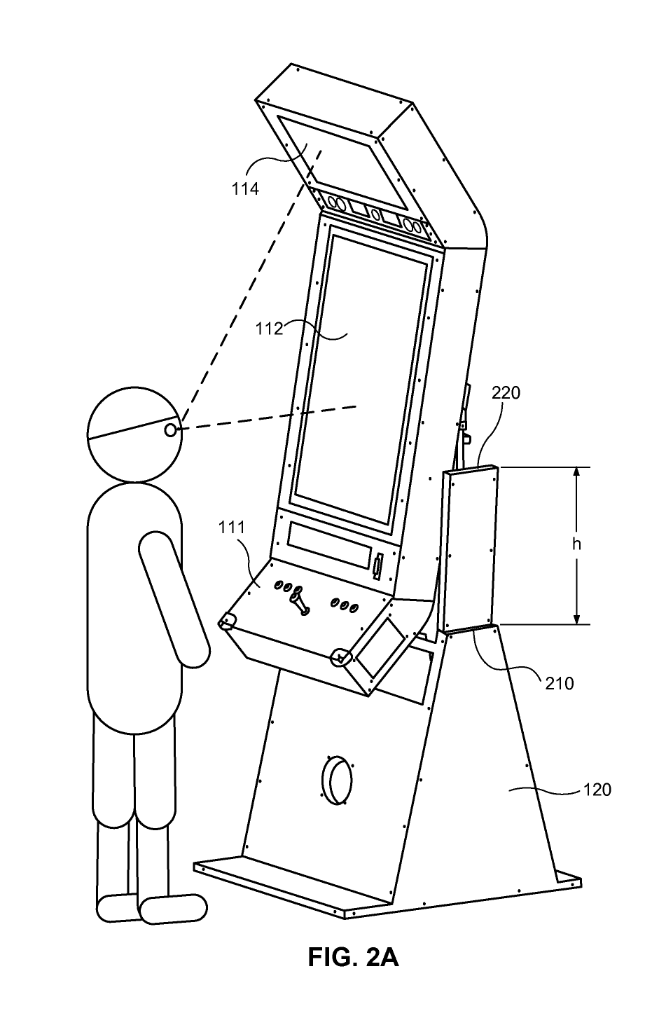

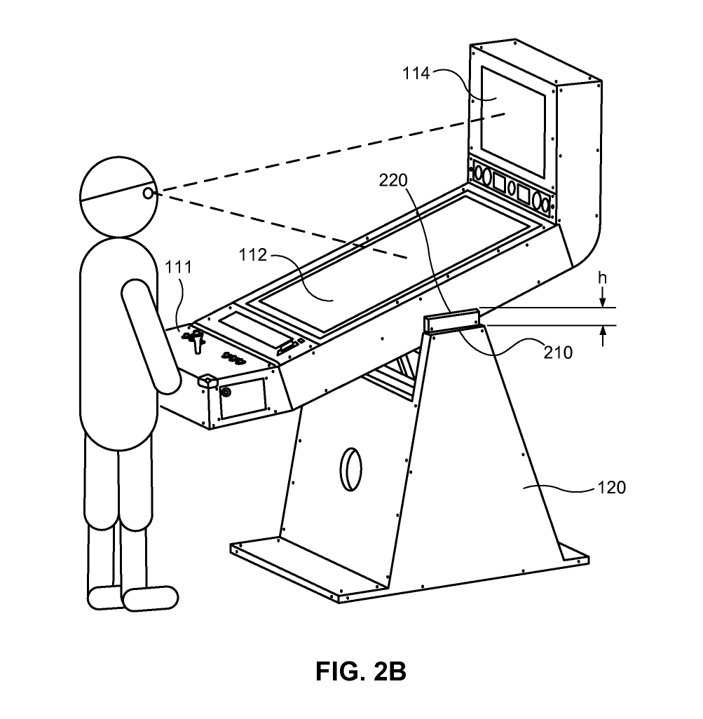

Referring now to FIGS. 2A and 2B, it is illustrated that, in an embodiment, an elevation of main display 112, defined as the vertical height of the mid point of main display 112, may be located in an ergonomically preferred position over a range of angular orientations. For example, if main display 112 is oriented approximately vertically, as illustrated in FIG. 2A, the height of the midpoint of main display 112 may be advantageously disposed at eye level of a player. On the other hand, if main display 112 is oriented at a tilt angle appropriate for a pinball game, for example, as illustrated in FIG. 2B, the height of the midpoint of main display 112 may be advantageously disposed well below eye level of a player. In an embodiment, control system 130 may be configured to automatically adjust the elevation of main display 112, by controlling a distance ‘h’ between a mounting interface 220 of main display 112 and a top fixed edge 210 of adjustable frame 120. The automatic adjustment may result in a change of the elevation of main display 112. The change in elevation may be from a first elevation associated with a first angle of inclination with respect to horizontal to a second elevation associated with a second angle of inclination with respect to horizontal. Advantageously, the elevation associated with a relatively high angle of inclination is higher than the elevation associated with a relatively low angle of inclination.

Advantageously, the elevation and angular orientation of main display 112 may be separately controllable by a player in a manner that is at least partially independent from the selection of game type. For example, a player may be enabled to customize the ergonomic “fit” of the game, to the player's personal comfort, by adjusting the elevation and angular orientation of main display 112 and user interface panel 111.

In an embodiment, one or more game play parameters of a simulated mechanical game may be affected by a value of a selected inclined angle. For example, if the simulated mechanical game is pinball, electronic game machine 110 may be configured to provide game action on main display 112 that varies as a function of the selected inclined angle. At a steeper inclined angle, for example, apparent gravitational acceleration of a simulated game object such as a ball may be greater, and a difficulty level of the game may be correspondingly increased.

Referring still to FIGS. 2A and 2B, control system 130 may also be configured to automatically adjust a position of user interface panel 111. For example, user interface panel 111 may be rotated and/or translated with respect to main display 112, to maintain an ergonomically appropriate position with respect to a player. In an embodiment, control system 130 may also be configured to automatically adjust a position of ancillary display 114. For example, ancillary display 114 may be rotated and/or translated with respect to main display 112, to maintain an ergonomically appropriate position with respect to a player. Advantageously, the position and angular orientation may be automatically positioned to provide a convenient viewing angle for the player and/or to provide an orientation of ancillary display 114 with respect to the viewing angle.

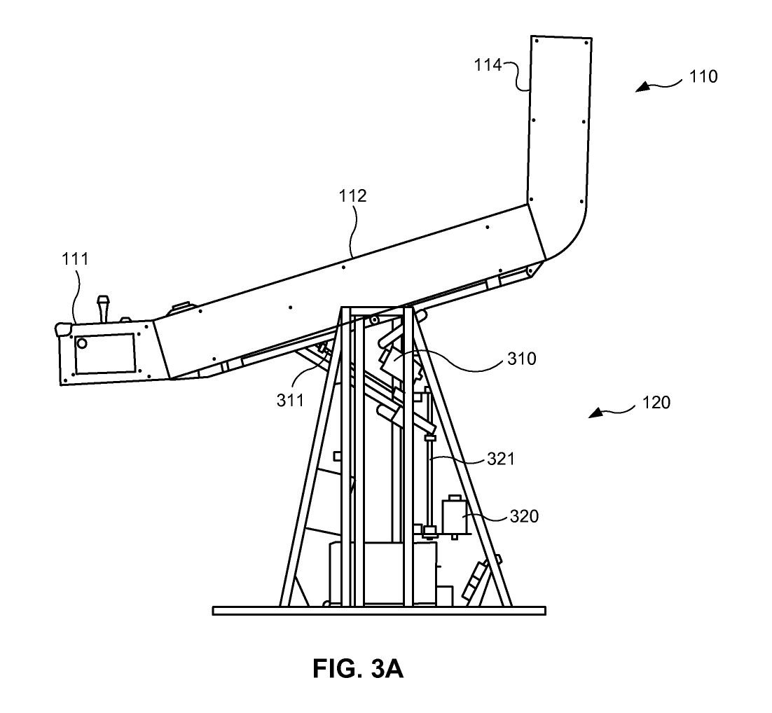

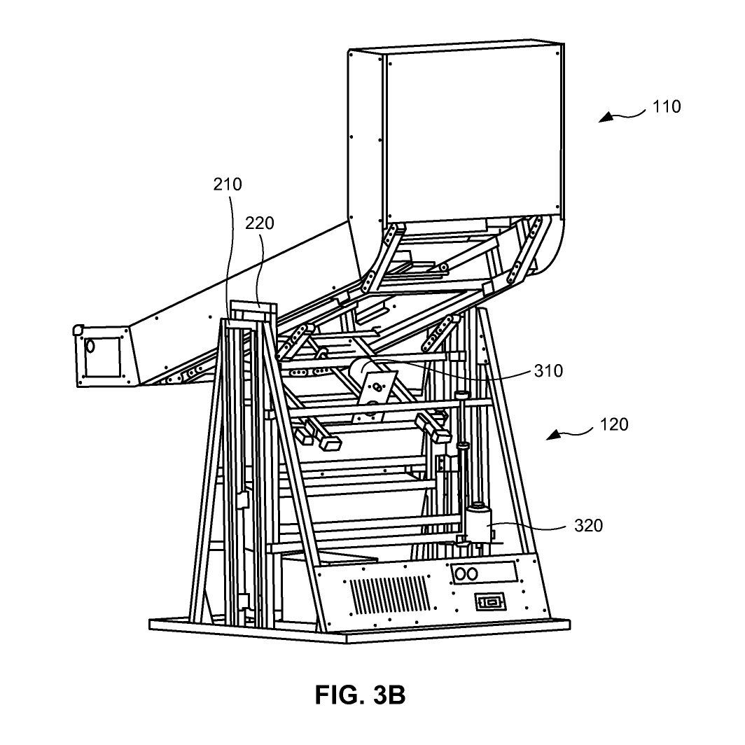

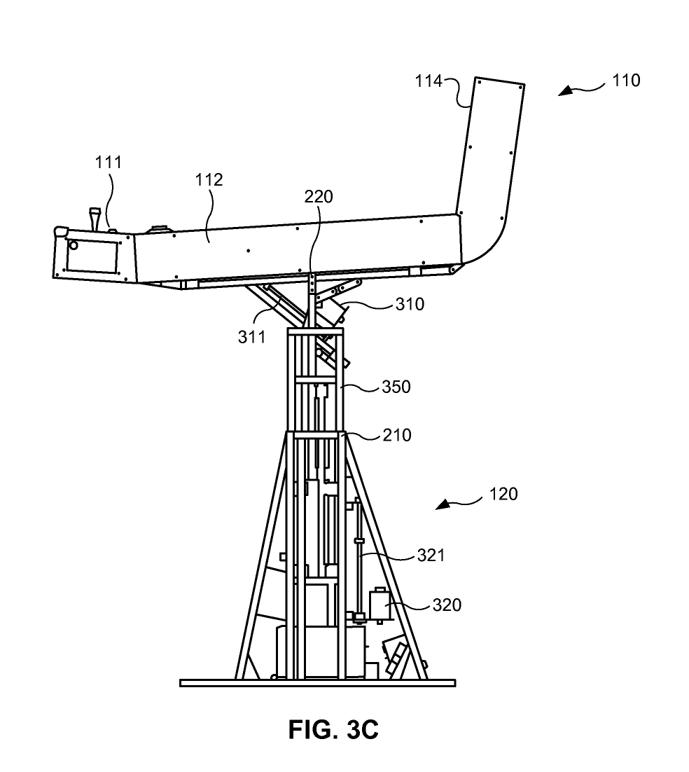

Referring now to FIGS. 3A and 3B, internal details of an embodiment of adjustable frame 120 are illustrated. A set of mechanisms that may be configured as part of control system 130, suitable for reconfiguring game machine 110 as described hereinabove are illustrated. In an embodiment, control system 130 may adjust a height and angular orientation of components of game machine 110 by way of mechanical actuators. For example, the height may be adjusted by motor 320 driving lead screw 321. An angular orientation of, for example main display 112 may be adjusted by motor 310 driving lead screw 311.

As illustrated in FIGS. 3B and 3C, adjustable frame 120 may be configured as a structure having a top fixed edge 210. In an embodiment, adjustable frame 120 may include a truss 350 that may be translated in a vertical axis, and have attachment devices to mounting interface 220 of main display 112. Truss 350 may be translated in the vertical direction by way, for example, of lead screw 321, driven by motor 320. Adjustable frame 120 may adjust the inclination angle of main display 112, by means of lead screw 311 driven by motor 310. Control system 130 may control motors 320 and 321 so as to automatically adjust the elevation of the main display from a first elevation associated with the first angle to a second elevation associated with the second angle. Appropriate linkages (not shown) may be provided to automatically adjust a respective position of user interface panel 111 and/or ancillary display 114.

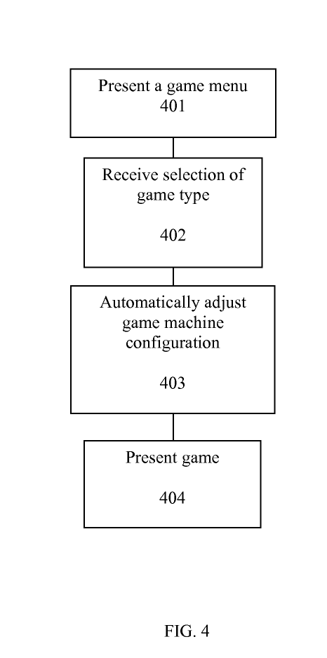

Referring now to FIG. 4, in an embodiment, at step 401, a menu of game types may be presented by electronic game machine 110, from which a user or game operator may select. In an embodiment, processor 115 may cause main display 112 to present the menu of game types.

A selection of a game type may be received, step 402, by processor 115. The selection may be received, for example, by way of an input made at user interface panel 111. After receiving the selection an automatic adjusting process, step 403, of the game machine configuration may be performed by control system 130. Advantageously, adjusting of the game machine configuration may result in adjusting the elevation of the main display from a first elevation associated with the first angle to a second elevation associated with the second angle, and automatically adjusting a respective position of, at least, the user interface panel. In an embodiment, a respective position of an ancillary display may also be adjusted. Following the adjustment, the selected game may be presented, step 404.

Thus, techniques for providing a reconfigurable game machine have been described. The various illustrative logics, logical blocks, modules, circuits and algorithm steps described in connection with the embodiments disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), ASIC, a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some embodiments, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the embodiments described in this disclosure may be readily apparent to those skilled in the art, and the generic principles defined herein may be applied to other embodiments without departing from the spirit or scope of this disclosure. Thus, the disclosure is not intended to be limited to the embodiments shown herein, but is to be accorded the widest scope consistent with the claims, the principles and the novel features disclosed herein. The word “exemplary” is used exclusively herein to mean “serving as an example, instance, or illustration.” Any embodiment described herein as “exemplary” is not necessarily to be construed as preferred or advantageous over other embodiments. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the device as implemented.

What is claimed is:

1. An apparatus, comprising:
an electronic game machine, an adjustable frame and a control system;
said electronic game machine comprising a main display, a user interface panel and a processor, said processor communicatively coupled to the main display, the user interface panel and the control system;
said adjustable frame being configured to support the main display at an angle and an elevation, said angle being adjustable by the control system between a first angle associated with a first game and a second angle associated with a second game; wherein
the control system is configured to (i) automatically adjust the elevation of the main display from a first elevation associated with the first angle to a second elevation associated with the second angle; and (ii) automatically adjust a respective position of the user interface panel.

2. The apparatus of claim 1, wherein the electronic game machine is configured to offer a game selected from any of a plurality of games, and the control system is configured to automatically position the adjustable frame so as to support the main display at an angle and an elevation appropriate to the selected game.

3. The apparatus of claim 2, wherein the first angle is substantially horizontal and the second angle is substantially vertical.

4. The apparatus of claim 2, wherein the adjustable frame is configured to automatically adjust a respective angle and elevation of the user interface panel, to maintain an ergonomically appropriate position with respect to a player.

5. The apparatus of claim 4, wherein the adjustable frame is configured to automatically adjust a respective angle and elevation of an ancillary display, to maintain an ergonomically appropriate position of the ancillary display with respect to the player.

6. The apparatus of claim 5, wherein the adjustable frame is configured to adjust a respective angle and elevation of an ancillary display, in response to an input from the player independent of the selected game.

7. The apparatus of claim 2, wherein the electronic game machine is a video game machine configured to simulate a game selectable from among a at least two of: roulette, craps, a slots game, a pachinko game, a pinball game, skeeball, foosball, and air hockey.

8. The apparatus of claim 7, wherein
the adjustable frame is configured to support the main display at a selectable inclined angle associated with a simulated game; and
at least one play parameter of the simulated game is affected by a value of a selected inclined angle.

9. The apparatus of claim 8, wherein at least one play parameter of the simulated game is affected by a value of a selected inclined angle.

10. The apparatus of claim 9, wherein the simulated game is pinball and the at least one play parameter is an apparent acceleration of a ball under the simulated effect of gravity.

11. An electronic game machine comprising
a main display, a user interface panel and a processor, said processor communicatively coupled to the main display, the user interface panel and a control system; wherein
the electronic game machine is configured to be supported by an adjustable frame, said adjustable frame being configured to support the main display at an angle and an elevation, said angle being adjustable by the control system between a first angle associated with a first game and a second angle associated with a second game; wherein
the control system is configured to (i) automatically adjust the elevation of the main display from a first elevation associated with the first angle to a second elevation associated with the second angle; and (ii) automatically adjust a respective position of the user interface panel.

12. The electronic game machine of claim 11, wherein the electronic game machine is configured to offer a game selected from any of a plurality of games, and the control system is configured to automatically position the adjustable frame so as to support the main display at an angle and an elevation appropriate to the selected game.

13. The electronic game machine of claim 12, wherein the first angle is substantially horizontal and the second angle is substantially vertical.

14. The electronic game machine of claim 12, wherein the adjustable frame is configured to automatically adjust a respective angle and elevation of the user interface panel, to maintain an ergonomically appropriate position with respect to a player.

15. The electronic game machine of claim 14, wherein the adjustable frame is configured to automatically adjust a respective angle and elevation of an ancillary display, to maintain an ergonomically appropriate position of the ancillary display with respect to the player.

16. The electronic game machine of claim 15, wherein the adjustable frame is configured to adjust a respective angle and elevation of an ancillary display, in response to an input from the player independent of the selected game.

17. The electronic game machine of claim 12, wherein the electronic game machine is a video game machine configured to simulate a game selectable from among a at least two of: roulette, craps, a slots game, a pachinko game, a pinball game, skeeball, foosball, and air hockey.

18. The electronic game machine of claim 17, wherein
the adjustable frame is configured to support the main display at a selectable inclined angle associated with a simulated game; and
at least one play parameter of the simulated game is affected by a value of a selected inclined angle.

19. The electronic game machine of claim 18, wherein at least one play parameter of the simulated game is affected by a value of a selected inclined angle.

20. The electronic game machine of claim 19, wherein the simulated game is pinball and the at least one play parameter is an apparent acceleration of a ball under the simulated effect of gravity.

21. An adjustable frame for supporting an electronic game machine, said adjustable frame being configured to support the main display at an angle and an elevation, said angle being adjustable by a control system between a first angle associated with a first game and a second angle associated with a second game, wherein
the electronic game machine comprises a main display, a user interface panel and a processor, said processor communicatively coupled to the main display, the user interface panel and the control system; and
the control system is configured to (i) automatically adjust the elevation of the main display from a first elevation associated with the first angle to a second elevation associated with the second angle; and (ii) automatically adjust a respective position of the user interface panel.

22. The adjustable frame of claim 21, wherein the electronic game machine is configured to offer a game selected from any of a plurality of games, and the control system is configured to automatically position the adjustable frame so as to support the main display at an angle and an elevation appropriate to the selected game.

23. The adjustable frame of claim 22, wherein the first angle is substantially horizontal and the second angle is substantially vertical.

24. The adjustable frame of claim 22, wherein the adjustable frame is configured to automatically adjust a respective angle and elevation of the user interface panel, to maintain an ergonomically appropriate position with respect to a player.

25. The adjustable frame of claim 24, wherein the adjustable frame is configured to automatically adjust a respective angle and elevation of an ancillary display, to maintain an ergonomically appropriate position of the ancillary display with respect to the player.

26. The adjustable frame of claim 25, wherein the adjustable frame is configured to adjust a respective angle and elevation of an ancillary display, in response to an input from the player independent of the selected game.

27. The adjustable frame of claim 22, wherein the electronic game machine is a video game machine configured to simulate a game selectable from among a at least two of: roulette, craps, a slots game, a pachinko game, a pinball game, skeeball, foosball, and air hockey.

28. The adjustable frame of claim 27, wherein
the adjustable frame is configured to support the main display at a selectable inclined angle associated with a simulated game; and
at least one play parameter of the simulated game is affected by a value of a selected inclined angle.

29. The adjustable frame of claim 28, wherein at least one play parameter of the simulated game is affected by a value of a selected inclined angle.

30. The adjustable frame of claim 29, wherein the simulated game is pinball and the at least one play parameter is an apparent acceleration of a ball under the simulated effect of gravity.

31. A method, comprising:
receiving, at a processor, by way of a user interface panel of an electronic game machine, a selection of a game, said electronic game machine comprising a main display, the user interface panel and the processor, and being configured to be supported by an adjustable frame, said adjustable frame being configured to support the main display at an angle and an elevation, said angle being adjustable by the control system between a first angle associated with a first game and a second angle associated with a second game; and
automatically adjusting, with the control system, (i) the elevation of the main display from a first elevation associated with the first angle to a second elevation associated with the second angle; and (ii) a respective position of the user interface panel.
